(19) United States
(12) Patent Application Publication
(10) Pub. No.: US 2013/0344247 A1
(43) Pub. Date: Dec. 26, 2013

(54) CATALYTIC CHEMICAL VAPOR DEPOSITION DEVICE, AND DEPOSITION METHOD AND CATALYST BODY SURFACE TREATMENT METHOD USING SAME

(71) Applicant: Sanyo Electric Co., Ltd., Moriguchi City (JP)

(72) Inventors: Tomonori Ueyama, Matsusaka-shi (JP); Motohide Kai, Osaka (JP)

(73) Assignee: Sanyo Electric Co., Ltd., Moriguchi City (JP)

(21) Appl. No.: 14/012,033

(22) Filed: Aug. 28, 2013

Related U.S. Application Data
(63) Continuation of application No. PCT/JP2012/054080, filed on Feb. 21, 2012.

(30) Foreign Application Priority Data
Mar. 3, 2011 (JP) 2011-045928

(51) Int. Cl. B05C 11/00; B01J 38/04

(52) U.S. Cl. CPC B05C 11/00; B01J 38/04
USPC 427/255.28; 502/34; 118/707

(57) ABSTRACT

A configuration is provided for a deposition device using the catalytic CVD method which reduces problems associated with extension of the catalyst and is superior in terms of running costs and productivity. The configuration provides a chamber 1 able to maintain reduced interior pressure; a source gas introducing route 32, 33a for introducing source gas into the chamber; a catalyst 4 of tantalum wire having a boride layer on the surface and provided inside the chamber 1 so as to allow the source gas introduced via the source gas introducing route to come into contact with the surface of the catalyst; a gas introducing route 36, 33b for introducing boron-containing gas to the chamber 1 for the reformation of the boride layer on the surface of the catalyst 4; and a power supply unit 5 for applying energy to the catalyst 4 to maintain the catalyst at a predetermined temperature. In this configuration, the introduction of the source gas is stopped, the catalyst 4 is heated while introducing diborane gas from the gas introducing route for reformation of the surface layer, and more boride is formed on the surface of the boride layer of the catalyst 4.

### CROSS-REFERENCE TO RELATED APPLICATIONS

This is a continuation of International Application PCT/JP2012/054080, with an international filing date of Feb. 21, 2012, filed by applicant, the disclosure of which is hereby incorporated by reference in its entirety.

### FIELD OF THE INVENTION

The present invention relates to a catalytic chemical vapor deposition device (catalytic CVD device) for breaking down a source gas and forming a predetermined thin film on the surface of a substrate, and a deposition method and a surface treatment method for a catalyst using the device.

### BACKGROUND

Devices using a conventional chemical vapor deposition (CVD) method have been used to deposit amorphous silicon (a-Si) film and polycrystalline silicon (poly-Si) film. The plasma CVD (PCVD) is especially popular because of its high throughput. When the PCVD method is used to deposit a-Si film, plasma is generated using high frequency at a gas pressure from 10 to 100 Pa, and the product generated in the plasma is deposited to form a film. A method that does not use plasma has recently been developed in which a catalyst maintained at a high temperature is placed inside a chamber and the action of the catalyst is used to deposit film. This method is known as the catalytic CVD (cat-CVD) method.

In a CVD method using a catalyst (referred to below as the catalytic CVD method), a film is formed at a sufficient rate despite the temperature of the substrate being lower than in a conventional thermal CVD method. Therefore, it is a very promising low-temperature process. Because plasma is not used, there are no problems such as damage to substrates due to plasma. By changing the type of gas introduced to the system, the method can be used not only with Si, but also to form diamond thin films and protective films for electronic devices (see, for example, Patent Document 1).

Forming a boride layer on the surface of tantalum (Ta) used as a catalyst has been proposed in order to extend the life of the catalyst used in the catalyst CVD method (see, for example, Patent Document 2).

Because the boride layer formed on the surface of the tantalum wire is harder than metallic tantalum, use as the catalyst of tantalum wire, on the surface of which is formed a boride layer, can reduce thermal extension, improve mechanical strength, and extend the life of the catalyst.

### CITED DOCUMENTS

### Patent Documents

Patent Document 1: Laid-Open Patent Publication No. 2009-108417

Patent Document 2: Laid-Open Patent Publication No. 2008-300793

### SUMMARY

### Problem Solved by the Invention

However, a catalyst with an even longer life is desired from the standpoint of improving productivity.

The present invention provides a configuration for a deposition device using the catalytic CVD method which reduces problems associated with extension of the catalyst and is superior in terms of running costs and productivity.

### Means of Solving the Problem

The present invention provides a deposition method using a catalytic chemical vapor deposition device, comprising: a chamber which can maintain reduced interior pressure; a source gas introduction route for introducing a predetermined source gas into the chamber; a catalyst of tantalum wire having a boride layer on the surface and provided inside the chamber so as to allow the source gas introduced via the source gas introduction route to pass by and come into contact with the surface of the catalyst; a gas introduction route for introducing boron-containing gas to the chamber for the reformation of the boride layer; and a power supply unit for applying energy to the catalyst to maintain the catalyst at a predetermined temperature, wherein the deposition method comprises: a boronization step of introducing the boron-containing gas from the gas introduction route, which is used to reintroduce the gas for forming the boride layer, while heating the catalyst for re-boronization of the surface of the boride layer of the catalyst and a deposition step of using the re-boronized catalyst to form a film on the surface of a substrate loaded into the chamber by introducing the source gas into the chamber from the source gas introduction route while heating the catalyst, and discharging the substrate from the chamber.

The present invention also provides a catalytic chemical vapor deposition device, comprising: a chamber which can maintain reduced interior pressure; a source gas introduction route for introducing a predetermined source gas into the chamber to form semiconductor that contains no boron; a catalyst of tantalum wire having a boride layer on the surface and provided inside the chamber so as to allow the source gas introduced via the source gas introduction route to pass by and come into contact with the surface of the catalyst; a gas introduction route for introducing boron-containing gas to the chamber for the reformation of the boride layer; a power supply unit for applying energy to the catalyst to maintain the catalyst at a predetermined temperature; and a control unit for controlling the gas introduced into the chamber.

In addition, the present invention provides a boride surface treatment method for a catalyst using a catalytic chemical vapor deposition device, comprising: a chamber which can maintain reduced interior pressure; a gas introduction route for introducing boron-containing gas to the chamber for the formation of the boride layer; a catalyst provided inside the chamber so as to allow the boron-containing gas introduced via the gas introduction route for formation of the boride layer to pass by and come into contact with the surface of the catalyst; a power supply unit for applying energy to the catalyst to maintain the catalyst at a predetermined temperature; and a control unit for controlling the gas introduced into the chamber, wherein the boride surface treatment method comprises the step of: heating the catalyst using the power supply unit while maintaining reduced pressure inside the chamber and introducing the boron-containing gas from the gas introduction route for reformation of the boride layer to treat the surface of the catalyst with boride.

### Effect of the Invention

The present invention is able to extend the life of the catalyst and improve productivity.

### BRIEF DESCRIPTION OF THE DRAWINGS

FIG. 1 is a front cross-sectional view of a catalytic CVD device of an embodiment.

FIG. 2 is a simplified perspective view showing the relationship between the catalyst and the substrate holder in the catalytic CVD device of the embodiment.

FIG. 3 is a schematic diagram showing the catalyst wire used in the catalytic CVD device of the embodiment.

FIG. 4 is a simplified perspective view used to explain an example of a configuration for the catalyst and gas introduction route in FIG. 1.

FIG. 5 is a schematic diagram showing an expanded catalyst wire in a catalytic CVD device.

FIG. 6 is a schematic diagram showing an expanded catalyst wire in the catalytic CVD device of the embodiment.

FIG. 7 is a schematic diagram showing the cross-sectional structure of the catalyst wire of the embodiment.

FIG. 8 is a schematic diagram showing an expanded catalyst wire in a catalytic CVD device of the prior art.

FIG. 9 is a schematic diagram showing the cross-sectional structure of a catalyst wire of the prior art.

FIG. 10 is a graph showing the relationship between the operating time and the rate of change in electrical resistance for the catalyst wire in the embodiment and for a catalyst wire of the prior art.

### DETAILED DESCRIPTION

The following is a detailed explanation of an embodiment with reference to the drawings. In the drawings, identical or similar components are denoted by the same reference numbers and the explanation of these components is not repeated in order to avoid redundancy.

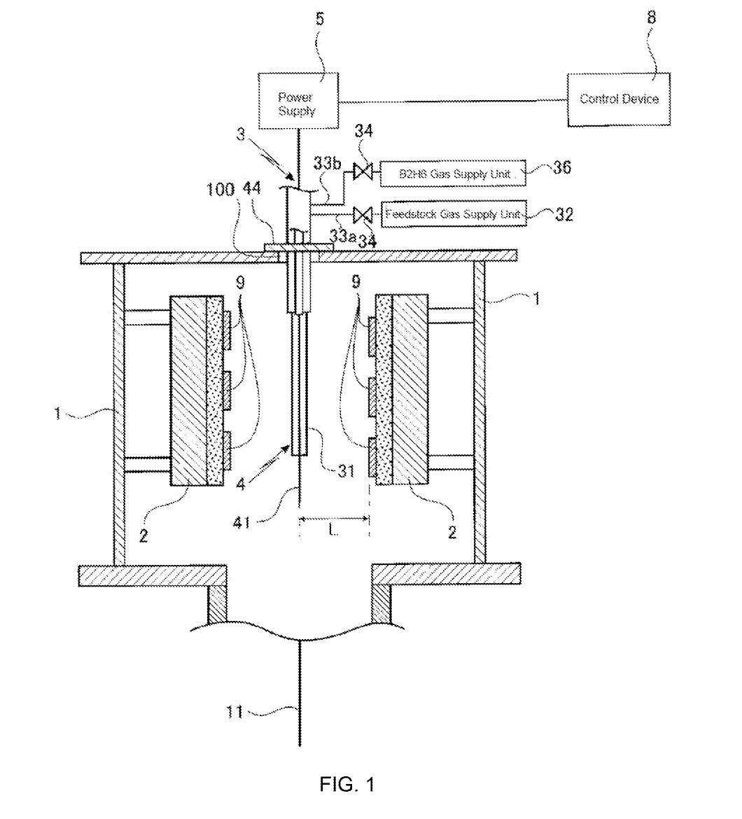

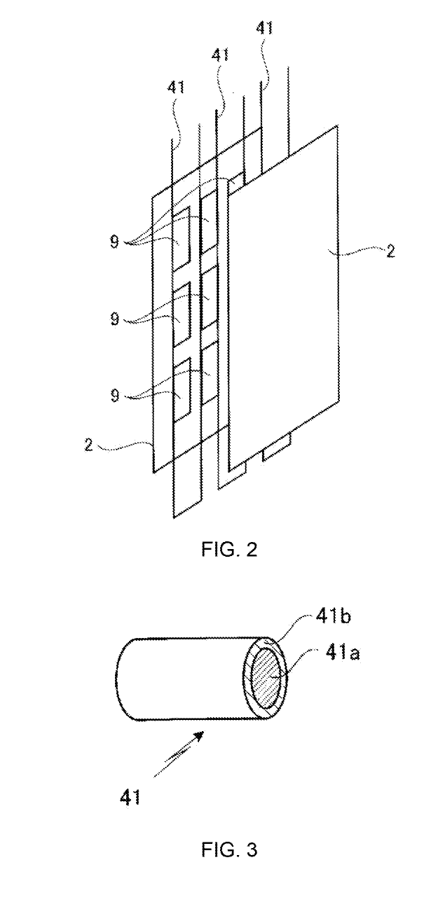

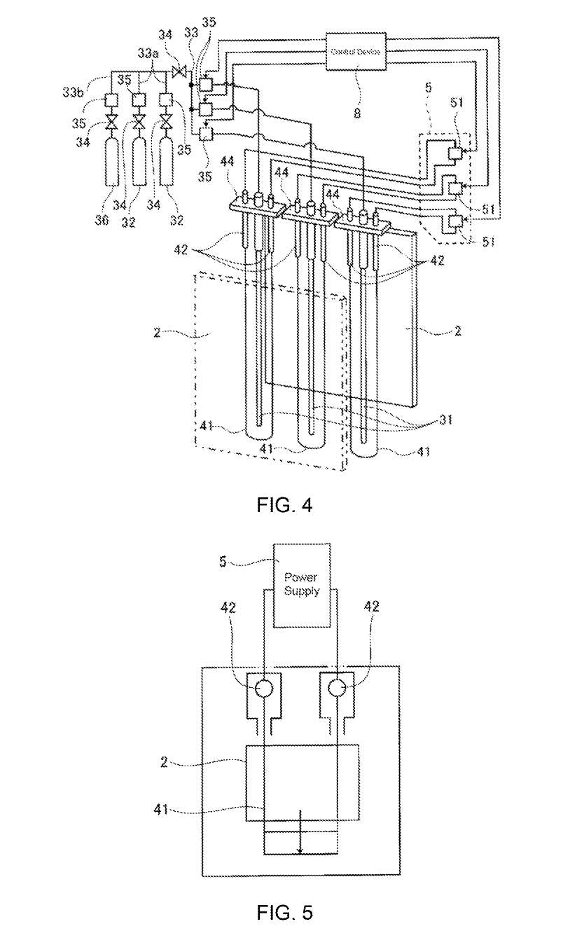

FIG. 1 is a front cross-sectional view of a deposition device in an embodiment, FIG. 2 is a simplified perspective view showing the relationship between the catalyst and the substrate holder in the deposition device of the embodiment, FIG. 3 is a schematic diagram showing the catalyst wire used in the catalytic CVD device in the embodiment, and FIG. 4 is a simplified perspective view used to explain an example of a configuration for the catalyst and gas introduction route in FIG. 1.

The device shown in FIG. 1 includes a chamber 1 which can maintain reduced interior pressure using an exhaust system 11; a substrate holder 2 for holding a substrate 9 in a predetermined position inside the chamber 1; a source gas introducing route 3 for introducing a predetermined source gas into the chamber 1 from a source gas supplying unit 32; a catalyst 4 provided inside the chamber 1 so as to allow the source gas introduced via the source gas introduction route 3 to pass by and come into contact with the surface of the catalyst; and a power supply unit 5 for applying energy to the catalyst 4 to maintain the catalyst 4 at a predetermined temperature. The present invention also has a diborane gas supplying unit 36 separate from the source gas supplying unit 32 which is used to supply diborane gas (B₂H₆) to the chamber 1 in order to treat the surface of the catalyst 4 (catalyst wire 41) with boride.

The source gas is supplied from the source gas supplying unit 32 to the gas introduction route 3 via a valve 34 and a conduit pipe 33a. When the catalyst 4 (catalyst wire 41) is treated with boride, diborane gas is supplied from the diborane gas supplying unit 36 to the gas introduction route 3 via the valve 34 and another conduit pipe 33b. As shown in FIG. 3, the catalyst wire 41 has a boride layer 41b formed on the surface of tantalum wire 41a. The use of tantalum wire 41a whose surface is coated with a boride layer 41b as the catalyst wire 41 reduces the thermal extension of the catalyst wire 41.

The chamber 1 is an airtight vacuum chamber having a gate value (not shown). The exhaust system 11 has a multistage vacuum pump, such as a combination of a turbomolecular pump and a rotary pump, which is used to purge the chamber 1.

As shown in FIG. 1 and FIG. 2, the substrate holder 2 holds the substrate 9 in a vertical position. The substrate holder 2 is arranged such that the surface holding the substrate 9 is vertical, and the substrate 9 is held by the substrate holding surface so as to maintain a vertical position. The substrate holder 2 can hold a plurality of substrates 9 simultaneously. There are two substrate holders 2 inside the chamber 1, and the two substrate holders 2 are arranged symmetrically with respect to the catalyst 4 (the catalyst wire 41). While not shown in the drawing, a substrate temperature control mechanism may be provided for controlling the temperature of the substrates 9, and keeps the substrates 9 at a predetermined temperature.

As shown in FIG. 1 and FIG. 2, the catalyst 4 in the device of the present embodiment is composed of a plurality of catalyst wires 41 extending parallel to the treated surface of the substrates 9 held by the substrate holders 2. Each catalyst wire 41 has a tantalum wire 41a and a boride layer 41b. It is clear from the simplified perspective view shown in FIG. 4 that a catalyst wire 41 is a single wire formed into a U-shape. Therefore, both ends of the wire are arranged at the top, and the curved portion is arranged at the bottom. The diameter of the wire is from 0.2 mm to 3 mm.

Both ends of each catalyst wire 41 arranged at the top are connected to an introduction holder 42. The introduction holder 42 is a wire or rod that is thicker than the catalyst wire 41. The introduction holder 42 is made of a high melting point metal similar to the catalyst wires 41.

The distance (L in FIG. 1) between the substrate 9 and the catalyst 4 is preferably from 1 cm to 20 cm in order to reduce the radiant heat from the catalyst 4 and for a sufficient amount of product to reach the substrate 9. If the distance is less than 1 cm, too much heat reaches the substrate 9. If the distance is greater than 20 cm, not enough product reaches the substrate 9.

As shown in FIG. 1 and FIG. 4, a holding plate 44 is provided for holding a pair of introduction holders 42. The introduction holders 42 pass through the holding plate 44 in an airtight fashion via an insulating material (not shown) with a high melting point, such as alumina. The holding plate 44 is preferably formed from a high melting point material such as alumina or pyrolytic-boron nitride (PBN). This holding plate 44 is mounted on the outside surface of the upper wall portion of the chamber 1. In other words, as shown in FIG. 1, an opening 100 smaller than the holding plate 44 is formed in the upper wall portion of the chamber 1, one opening for each holding plate 44 that is used. The introduction holder 42 held by each holding plate 44 extends downward through the opening 100 and the bottom end is connected to the catalyst wire 41.

A vacuum seal (not shown) is provided between each holding plate 44 and the outer surface of the upper wall portion of the chamber 1 to create an airtight seal for each holding plate 44 around the opening 100. Each holding plate 44 is mounted on the upper portion of the chamber using screws. When heat radiating from the chamber 1 through the holding plates 44 becomes a problem, a heat insulating material is provided between the holding plates 44 and the chamber 1.

As shown in FIG. 4, the power supply unit 5 consists of a plurality of power supplies 51, the number of power supplies is equal to the number of catalyst wires 41. Each power supply 51 supplies alternating current or direct current to a catalyst wire 41 to heat the wire. The catalyst wire 41 is heated to a predetermined temperature (for example, a temperature from 1,600° C. to 2,200° C.) to break down the source gas. Each power supply 51 is connected to the control device 8. The control device 8 controls each power supply 51, and controls the current to each catalyst wire 41 individually. As a result, the temperature of each catalyst wire 41 is controlled separately.

Having the same number of power supplies 51 as the number of catalyst wires 41 is not an essential precondition. For example, the catalyst wires 41 can be connected in series and a control element (such as variable resistance) can be provided to control each circuit. Here, the number of power supplies 51 is less than the number of catalyst wires 41.

Tantalum wire 41a with a boride layer 41b formed on the surface is harder than tantalum wire without a boride layer. Therefore, the use of tantalum wire 41 with a boride layer 41b formed on the surface as a catalyst wire 41 can reduce the extension of the catalyst wire 41 due to a rise in temperature.

As shown in FIG. 1 or FIG. 4, the gas introduction route 3 includes a gas introduction head 31 provided inside the chamber 1, a cylinder 32 of compressed source gas provided outside of the chamber 1, conduit pipes 33, 33a, and 33b linking a cylinder 36 of compressed diborane gas to the gas introduction head 31, a valve 34 provided in conduit pipe 33, a flow regulator 35, and a filter (not shown). As shown in FIG. 4, the number of gas introduction heads 31 is equal to the number of catalyst wires 41.

As shown in FIG. 4, the gas introduction heads 31 are connected to the gas introduction route 3, and the number provided is equal in number to the catalyst wire 41. Each gas introduction head 31 is a slender vertical pipe positioned inside the U-shaped inner portion of each U-shaped catalyst wire 41. In other words, each gas introduction head 31 is provided along the same plane as the vertical surface created by each catalyst wire 41. Therefore, as in the case of each catalyst wire 41, each gas introduction head 31 is parallel to the substrate 9 held by the substrate holder 2. Each gas introduction head 31 is formed from a high melting point metal or quartz.

Each gas introduction head 31 has a plurality of gas discharging holes (not shown) on the side surface opposite the substrate 9. As shown in FIG. 4, the conduit pipe 33 in the gas introduction route 3 has branches equal in number to the number of gas introduction heads 31, and the tips are connected to a gas introduction head 31. A flow regulator 35 is provided in each conduit pipe 33 after the branch. The control device 8 can control each flow regulator 35 individually. In the present embodiment, the flow rate of the source gas introduced into the chamber 1 from each gas introducing head 31 can be controlled individually. In the present specification, “source gas” refers to the gas introduced to deposit film. This includes gas that contributes directly to the formation of film, and gas that does not contribute directly to the formation of film such as carrier gas or buffer gas. For example, silane gas (SiH₄) can be stored in one cylinder 32 of compressed source gas, hydrogen gas (H₂) can be stored in another cylinder 32 of compressed source gas, and the gases can be discharged from a gas introduction head 31 via the gas introduction route 3.

As the deposition process is repeated, each catalyst wire 41 expands downward as shown in FIG. 5. If this continues, the boride film surrounding the catalyst wires 41 deteriorates, and the rate of extension of each catalyst wire 41 increases.

In the present invention, the temperature is kept above 600° C. When the cumulative film-forming operating time exceeds a predetermined amount of time, the boride layer on the surface of catalyst wire 41 is treated with more boride. In the present embodiment, a supply line is provided in the chamber 1 for diborane gas which is not required to form intrinsic a-Si film. The diborane gas is selectively supplied only when the catalyst wires 41 are to be treated with more boride. The diborane gas is supplied to the gas introduction route 3 from a compressed gas cylinder 36 containing diborane gas via the valve 34 and the conduit pipe 33b, and the diborane gas is introduced to the chamber 1 from the gas introduction head 31.

During boride treatment, the supply of source gas is stopped, the diborane gas is supplied, and electrical current is applied through the catalyst wires 41. The vacuum pump is activated to create a vacuum inside the chamber 1 at a predetermined vacuum level (for example, 1 Pa or less). Next, the diborane gas is introduced to the chamber 1 from the diborane gas supplying unit 36, and the control device 8 is turned on to flow the electrical current through each catalyst wire 41 to attain a temperature at which diborane gas breaks down (for example, a temperature above 1,700° C.). The diborane gas is supplied at a B₂H₆/H₂ (2%) flow rate from 100 sccm to 1,000 sccm, the pressure is maintained from 0.5 Pa to 10 Pa, and electrical currents are conducted through the wires for anywhere from several minutes to several dozen minutes.

At this time, the catalyst wires 41 are treated with boride and the surface changes from the state shown in FIG. 7 (a) to the state shown in FIG. 7 (b). In other words, the diborane gas makes contact with the surface of a catalyst wire 41 and the reaction product forms another boride layer 41c on the boride layer 41b on the surface of the tantalum wire 41a. As a result, the boride layers 41b, 41c increase the thickness of the overall boride layer and this can hold down the extension rate of the catalyst wire 41.

The following is an explanation of the operation of the deposition device of the present embodiment. A substrate holder 2 holding a plurality of substrate 9 is loaded into the chamber 1.

The gate value of the chamber 1 is closed, the exhaust system 11 reduces the pressure inside the chamber 1 to a predetermined level, the gas introduction route 3 is activated, and the source gas is introduced to the chamber 1 at a predetermined flow rate. In other words, the source gas is supplied from the gas discharge holes in each gas introduction head 31, and is dispersed inside the chamber 1. At this time, the flow regulators 35 provided in the gas introduction route 3 are controlled by the control device 8 so that the flow rate of source gas introduced into the chamber 1 from each gas introduction head 31 can be controlled individually. The exhaust system 11 in the chamber 1 has an exhaust rate regulator to control the exhaust rate and reach the predetermined vacuum level inside the chamber 1. The source gas is introduced from the source gas supplying unit 32 into the chamber 1. In the present embodiment, silane (SiH₄) gas and hydrogen gas (H₂) constitute the source gas, and silicon film (Si) is formed on the surface of the substrate 9. More specifically, the source gas is supplied to the substrates 9.

Electric current is supplied from the power supplies 51 of the power supply unit 5 to each catalyst wire 41 constituting the catalyst 4, and each catalyst wire 41 is raised to a predetermined temperature. The source gas supplied from each gas introduction head 31 breaks down when making contact with or passing over the surface of the catalyst wires 41, producing a reaction product. This product reaches the surface of a substrate 9. As this process is repeated, a thin film based on the source gas grows on the surface of the substrate. More specifically, the substrate 9 is a monocrystal silicon substrate, the source gas is supplied to the substrate 9, and an intrinsic a-Si film is grown.

When this state has been maintained for a predetermined amount of time and a thin film has been formed to have a predetermined thickness, the operation of the gas introduction route 3 and the power supply unit 5 is stopped. After the chamber 1 has been purged again by the exhaust system 11, an inert gas is introduced, and the chamber 1 is raised to atmospheric pressure. When the chamber 1 has been raised to atmospheric pressure, the gas value is opened, and the substrates 9 are removed from the chamber 1.

As the deposition operation is repeated, each catalyst wire 41 expands downward as explained above. In the present embodiment, the catalyst wires 41 are subjected to boride treatment to prevent decomposition of the catalyst wires 41 during continued use, hold down the rate of extension of the catalyst wires 41, stabilize film quality, and extend the maintenance cycle of the deposition device.

When the catalyst wires 41 have been treated with more boride, the substrate holder 2 holding a plurality of substrate 9 is loaded in the chamber 1 again, and the boride-treated catalyst wires 41 are used to deposit film on the surface of the substrates 9. The deposition of film using the boride-treated catalyst wires 41 is repeated for a predetermined amount of time at a temperature above 600° C.

Next, the extension of catalyst wires with a boride layer on the surface which were treated again with boride, and the extension of catalyst wires with a boride layer on the surface which were left untreated, were determined after continuous use.

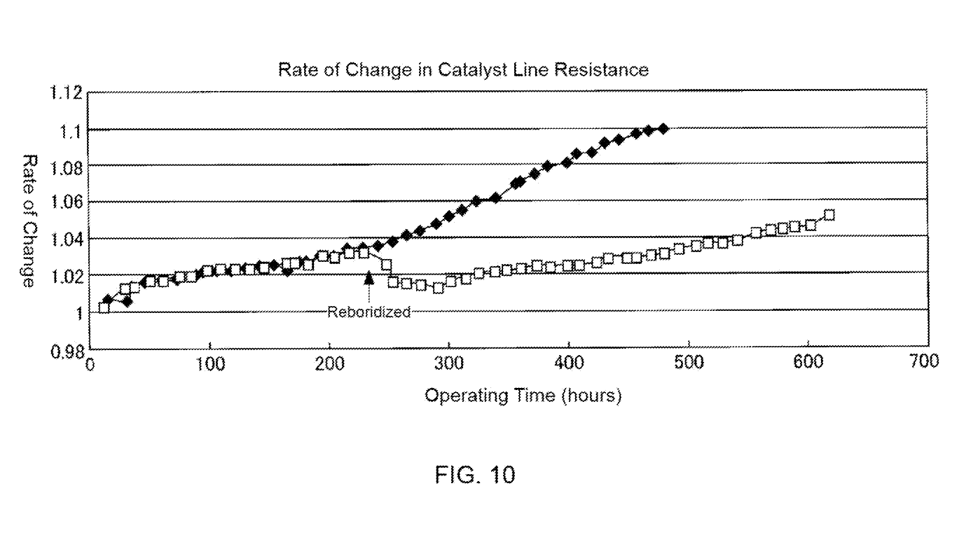

The results are shown in FIG. 10. The extension of the catalyst wires 41 is indicated by the change over time in the resistance of the catalyst wires. In this test, the same catalyst wires 41 with a boride layer on the surface were used continuously. The operation was performed continuously at a temperature above 600° C. The change in extension was determined by the change in resistivity. The results are confirmed based on the degree to which the rate of extension increases with respect to the passage of operation time in a state in which the initial value is 1.

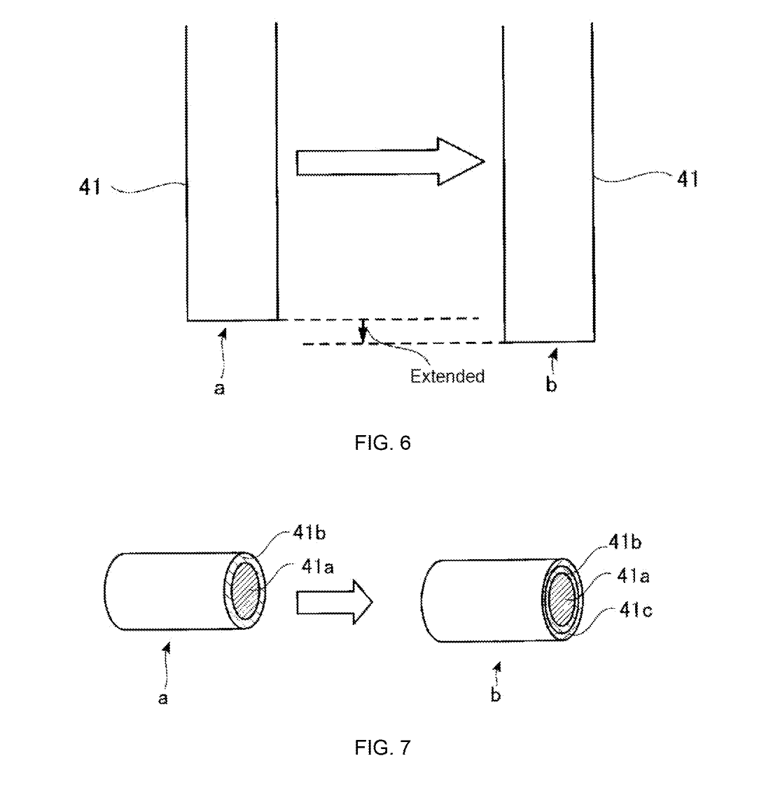

FIG. 6 and FIG. 7 show the extension of a catalyst wire 41 that has been treated again with boride and the condition of the catalyst wire. The initial state of the catalyst wire 41 is shown in FIG. 7 (a), and the state of the catalyst wire 41 after treatment with more boride is shown in FIG. 7 (b). The initial state of the catalyst wire 41 is shown in FIG. 6 (a), and the state of the catalyst wire 41 more than 200 hours after treatment with boride and more than 400 hours of cumulative operation is shown in FIG. 6 (b).

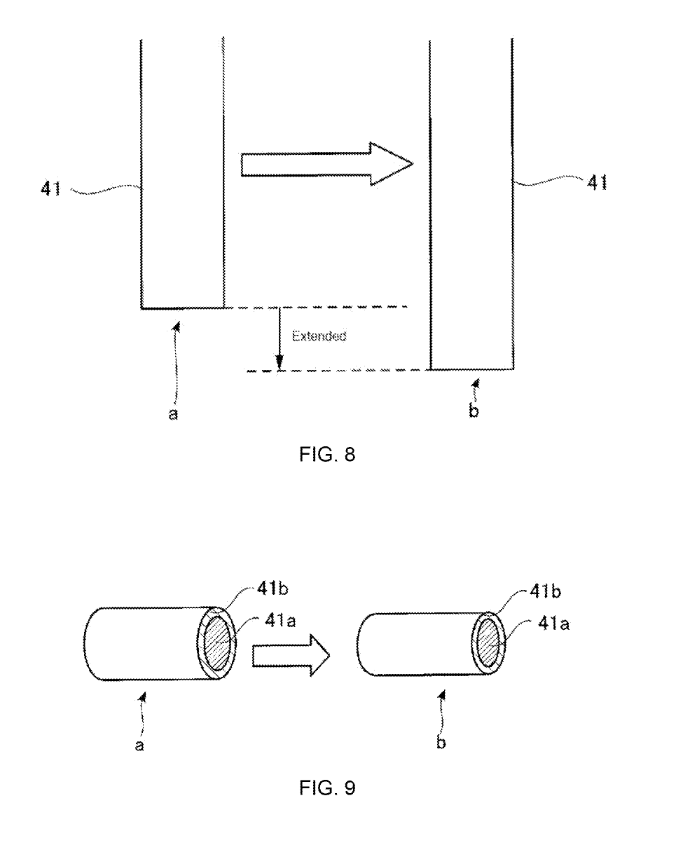

FIG. 8 and FIG. 9 show a catalyst wire 41 with a boride layer formed on the surface which has been used continuously without further modification. The initial state of the catalyst wire 41 is shown in FIG. 8 (a) and FIG. 9 (a), and the state of the catalyst wire 41 after more than 400 hours of operation is shown in FIG. 8 (b) and FIG. 9 (b).

In FIG. 10, the black diamonds indicate the extension rate of a catalyst wire with a boride layer formed on the surface which has been used without further modification, and the white squares indicate the extension rate of a catalyst wire with a boride layer formed on the surface which has been treated again with boride. In the present embodiment, the boride treatment was performed after 200 hours of operation. As shown in the schematic diagram in FIG. 9, the tantalum wire 41a expands after continuous use and the diameter of the wire becomes narrower. This is believed to make the boride layer 41b on the surface thinner, and cause the rate of extension to increase over time.

After the embodiment has been treated again with boride, the rate of extension, which had been 1.03, falls to 1.02 as shown in FIG. 10. In other words, the subsequent rise in the rate of extension has actually been reduced. As shown in the schematic diagram in FIG. 7, the boride layer 41c treated once more with boride makes the surface of the catalyst wire 41 harder, which is believed to hold down the rate of extension.

The following is a specific example of deposition in which an intrinsic a-Si (amorphous silicon) film is formed. The source gas is monosilane at a flow rate from 10 sccm to 500 sccm mixed and introduced with hydrogen gas at a flow rate from 20 sccm to 1,000 sccm. When the temperature of the catalyst 4 is maintained at a temperature from 1,500° C. to 2,200° C. and the chamber 1 is maintained at a pressure from 0.1 Pa to 10 Pa, a-Si film can be formed at a deposition rate from 30 to 250 Å per minute. When the instrinsic a-Si film is deposited, the boride on the surface of the catalyst 4 is supplied to the substrate 9 along with the source gas. Therefore, a trace amount of boron is added to the a-Si film deposited on the substrate 9. This a-Si film can be used effectively as the intrinsic a-Si film in a solar cell.

A supply line for diborane gas is not needed by the deposition device of the present embodiment when the intrinsic a-Si film is being formed. The diborane gas is selectively supplied when the catalyst wires are to be treated again with boride. The deposition device of the present embodiment can be applied to a chamber for depositing p-type a-Si film or to a chamber for depositing n-type a-Si film. In the case of a chamber for depositing p-type a-Si film, the boride treatment is performed using the supply line for diborane gas provided in the chamber. In the case of a chamber for depositing n-type a-Si film, a supply line for diborane gas is not usually provided. However, diborane gas may be selectively supplied to perform boride treatment. The boron-containing gas used in the boride treatment can be any gas containing boron broken down by the catalyst. In other words, a gas other than diborane gas can be used.

The boride treatment is effective immediately after installation, after a predetermined number of deposition operations, and after a certain amount of time has elapsed. The thickness of the boride layer on the surface immediately after boride treatment is believed to change. If the deposition conditions are adjusted to take into account this thickness, stable film quality can be expected.

After the boride treatment, the treatment can be performed several times on dummy substrate in order to obtain intrinsic a-Si film.

When the catalyst wire 41 is U-shaped, both ends can be attached to an electric current introducing unit on the bottom, and the curved portion at the top can be hung on a hook. However, when fixed on the bottom, the wire expands horizontally due to thermal extension. Therefore, a configuration in which both ends are at the top is preferred. The wire does not have to have a U-shape. It can have a U shape connected on the side, or a rounded w or m shape. The configuration of the device is not limited to the embodiment described above. Other configurations can be used.

In the embodiment described above, a-Si film was deposited. However, the device of the present invention can be used to coat other types of thin film, such as silicon nitride film or polysilicon film. The substrate 9 on which film is deposited may be a wafer used to create a semiconductor device or a liquid-crystal substrate used to create a liquid crystal display. When the substrate 9 has a large area, the substrate 9 may be loaded directly into a chamber 1 without using substrate holders 2.

The embodiments described above are for illustrative purposes only in every respect and do not impose limitations on the present invention. The scope of the present invention is defined by the scope of the claims and not by the description of the embodiments, and includes everything equivalent in meaning to the scope of the claims and all modifications therein.

### KEY TO THE DRAWINGS

1: Chamber
11: Exhaust System
2: Substrate Holder
3: Gas Introduction Route
31: Gas Introduction Head
32: Source Gas Supply Unit
35: Flow Regulator
36: Diborane Gas Supply Unit
4: Catalyst
41: Catalytic Wire
41a: Tantalum Wire
41b, 41c: Boride Layers
5: Power Supply Unit
51: Power Supply
8: Control Device
9: Substrate

What is claimed is:

1. A deposition method using a catalytic chemical vapor deposition device comprising:
a chamber able to maintain reduced interior pressure; a source gas introduction route for introducing a predetermined source gas into the chamber;
a catalyst of tantalum wire having a boride layer on its surface and provided inside the chamber so as to allow the source gas introduced via the source gas introduction route to pass by and come into contact with the surface of the catalyst;
a gas introduction route for introducing boron-containing gas to the chamber for the reformation of the boride layer; and
a power supply unit for applying energy to the catalyst to maintain the catalyst at a predetermined temperature,
where the deposition method step comprises:
a boronization step of introducing the boron-containing gas from the gas introduction route, which is used to reintroduce the gas for forming the boride layer, while heating the catalyst for re-boronization of the surface of the boride layer of the catalyst, and introduction route
and a deposition step of using the re-boronized catalyst to form a film on the surface of a substrate loaded into the chamber by introducing the source gas into the chamber from the source gas introduction route while heating the catalyst, and discharging the substrate from the chamber.introduction route

2. The deposition method of claim 1, wherein the deposition is repeated a certain number of times after boride treatment, and then the boride treatment is performed again.

3. The deposition method of claim 1, wherein the film deposited on the surface of the substrate is an amorphous silicon film.

4. A catalytic chemical vapor deposition device comprising:
a chamber able to maintain reduced interior pressure;
a source gas introduction route for introducing a predetermined source gas into the chamber;
a catalyst of tantalum wire having a boride layer on its surface and provided inside the chamber so as to allow the source gas introduced via the source gas introduction route to pass by and come into contact with the surface of the catalyst;
a gas introduction route for introducing boron-containing gas to the chamber for the reformation of the boride layer;
a power supply unit for applying energy to the catalyst to maintain the catalyst at a predetermined temperature; and
a control unit for controlling the gas introduced into the chamber.

5. The catalytic chemical vapor deposition device according to claim 4, wherein the control unit stops the introduction of the source gas, heats the catalyst while introducing boron-containing gas from the gas introduction route for reformation of the surface layer, and controls the introduction of the boron-containing gas and the electrical current running through the catalyst to perform boride treatment on the surface of the boride layer on the catalyst.

6. A surface treatment method for a catalyst using a catalytic chemical vapor deposition device comprising: a chamber able to maintain reduced interior pressure; a gas introducing route for introducing boron-containing gas to the chamber for the reformation of the boride layer; a catalyst provided inside the chamber so as to allow the boron-containing gas introduced via the gas introducing route for reformation of the boride layer to pass by and come into contact with the surface of the catalyst; a power supply unit for applying energy to the catalyst to maintain the catalyst at a predetermined temperature; and a control unit for controlling the gas introduced into the chamber,
where the surface treatment method step comprises: heating the catalyst using the power supply unit while maintaining reduced pressure inside the chamber and introducing the boron-containing gas from the gas introduction route for reformation of the boride layer to treat the surface of the catalyst with boride.

7. A amorphous silicon film deposition method using a catalytic chemical vapor deposition device comprising:
a chamber able to maintain reduced interior pressure; a source gas introducing route for introducing a predetermined source gas into the chamber;
a catalyst of tantalum wire having a boride layer on the surface and provided inside the chamber so as to allow the source gas introduced via the source gas introducing route to pass by and come into contact with the surface of the catalyst;
a gas introducing route for introducing boron-containing gas to the chamber for the reformation of the boride layer; and
a power supply unit for applying energy to the catalyst to maintain the catalyst at a predetermined temperature,
where the deposition method comprises:
introducing the source gas into the chamber from the source gas introducing route while heating the catalyst, and
depositing a film using the catalyst on the surface of a substrate loaded into the chamber, and discharging the substrate from the chamber.
